(19) United States
(12) Patent Application Publication
(10) Pub. No.: US 2019/0153904 A1
(43) Pub. Date: May 23, 2019

(54) ARRANGEMENT FOR AN EXHAUST SYSTEM OF A COMBUSTION ENGINE COMPRISING TWO WHR BOILERS

(71) Applicant: SCANIA CV AB, Södertälje (SE)

(72) Inventors: Zoltan KARDOS, Södertälje (SE); Stefan TREUTIGER, Södertälje (SE); Thomas SEDERHOLM, Hägersten (SE)

(73) Assignee: SCANIA CV AB, Södertälje (SE)

(21) Appl. No.: 16/091,405

(22) PCT Filed: Mar. 31, 2017
(86) PCT No.: PCT/SE2017/050315

§ 371 Date: Oct. 4, 2018

(30) Foreign Application Priority Data
Apr. 13, 2016 (SE) 1650498-7

(51) Int. Cl. F01K 23/06; F02G 5/02; F01N 3/20; F01N 5/02; F01N 9/00; F01K 15/02; F01K 23/10

(52) U.S. Cl. CPC F01K 23/065; F02G 5/02; F01N 3/2066; F01N 2900/1404; F01N 9/007; F01K 15/02; F01K 23/101; F01N 5/02

(57) ABSTRACT

The present invention relates an arrangement for an exhaust system of a combustion engine. The arrangement comprises at least one exhaust treatment component arranged in the exhaust system, a first boiler of a Waste Heat Recovery System (WHR) system arranged in an upstream position of the exhaust treatment component in the exhaust system, a second boiler of the WHR system arranged in a downstream position of the exhaust treatment component in the exhaust system and a working medium circuit circulating a working medium in the WHR system. The working medium circuit comprises a first conduit directing the working medium to the first boiler, a first bypass conduit directing the working medium past the first boiler, and a first valve device configured to regulate the working medium flow through the first conduit and the first bypass conduit.

### CROSS-REFERENCE TO RELATED APPLICATION(S)

This application is a national stage application (filed under 35 § U.S.C. 371) of PCT/SE2017/050315, filed Mar. 31, 2017 of the same title, which, in turn claims priority to Swedish Application No. 1650498-7, filed Apr. 13, 2016 of the same title; the contents of each of which are hereby incorporated by reference.

### FIELD OF THE INVENTION

The present invention relates to an arrangement for an exhaust system of a combustion engine comprising two Waste Heat Recovery System (WHR) boilers.

### BACKGROUND OF THE INVENTION

Exhaust systems of combustion engines such as diesel engines may comprise a plurality of exhaust treatment components such as, for example, a SCR catalyst (Selective Catalytic Reduction). In order to clean the exhaust gases from nitrogen oxides, a urea solution is sprayed into the exhaust line in a position upstream of the SCR catalyst. The urea solution is vaporized by the hot exhaust gases so that ammonia is formed. The ammonia and nitrogen oxides in the exhaust gases react with each other in the SCR catalyst so that nitrogen gas and water vapor are formed. The efficiency of a SCR catalyst depends on its temperature. The ability of the SCR catalyst to reduce nitrogen oxides is optimal within a temperature range which may be about 300-450° C. At lower and higher exhaust gas temperatures the capacity of the SCR catalyst to reduce nitrogen oxides is reduced.

WHR system (Waste Heat Recovery System) can be used for recovering waste thermal energy and convert it to mechanical energy or electric energy. A WHR system includes a pump which pressurizes and circulates a working medium in a closed circuit. The circuit comprises a boiler where the working medium is heated and evaporated by a heat source such as, for example, exhaust gases. The pressurized and heated gaseous working medium expands in an expander. The expander generates mechanical energy which can be used to support the engine and apparatuses in a vehicle. Alternatively, the expander is connected to a generator generating electric energy. The working medium leaving the expander is directed to a condenser. The working medium is cooled down in the condenser to a temperature at which it condenses. The fuel consumption of a combustion engine can be reduced by means of a WHR-system.

The exhaust gases are cooled down in a boiler of a WHR system. In view of this fact, the boiler is arranged in a downstream position of the exhaust treatment components. In this position, the existence of the boiler does not influence on the operation of the exhaust treatment components. However, in case when the combustion engine is high loaded during a longer period of time, there is a risk that the exhaust gases heat the exhaust treatment components to a high temperature at which the exhaust treatment components do not provide an optimal treatment of the exhaust gases.

### SUMMARY OF THE INVENTION

The object of the present invention is to provide an arrangement for an exhaust system of a combustion engine where an exhaust treatment component provides a substantially optimal treatment of the exhaust gases at the same time as a WHR system converts heat energy from the exhaust gases with a high efficiency during substantially all operating conditions.

The above mentioned object is achieved by the arrangement according to the claims. The WHR system comprises a first boiler arranged in the exhaust system in an upstream position of an exhaust treatment component and a second boiler arranged in a downstream position of the exhaust treatment component. The working medium may be evaporated in the second boiler and superheated in the first boiler. Furthermore, the WHR system comprises a first conduit directing working medium to the first boiler, a first bypass conduit directing the working medium past the first boiler, and a first valve device regulating the working medium flow through the first conduit and the first bypass conduit. The efficiency of a treatment component of exhaust gases is usually optimal within a specific temperature range. By regulation of the first valve device it is possible to direct an adjustable part of the evaporated working medium to the first boiler and a remaining part of it past the first boiler.

The adjustable working medium flow through the first boiler makes it is possible to regulate the temperature of the exhaust gases and the temperature of the downstream located exhaust treatment. As long as the exhaust treatment component has a temperature within said optimal temperature range, it is possible to superheat the working medium in the first boiler in a substantially optimal manner and provide an efficient operation of the WHR system. Furthermore, the higher temperature difference between the exhaust gases and the working medium in the upstream located boiler makes it possible to reduce the total size of the two boilers in relation to the size of one conventional boiler located downstream of the exhaust treatment component. The first valve device may comprise a three way valve. Alternatively, the first valve device may comprise a two-way valve controlling the working medium flow through the first conduit and another two way valve controlling the working medium flow through the first bypass conduit.

According to an embodiment of the invention, the working medium circuit comprises a second conduit directing the working medium to the second boiler, a second bypass conduit directing the working medium past the second boiler, and a second valve device configured to regulate the working medium flow through said second conduit and the second pass conduit. During most operating conditions, the second valve device regulates the entire working medium flow through the second boiler. In these cases, the WHR system absorbs heat in an optimal manner in the second boiler. However, during operating conditions when the temperature of the exhaust treatment component is too high despite the fact that the first valve device regulates the entire working medium flow through the first boiler, it is possible to control the second valve device such that the working medium is directed past the second boiler. In this case, unvaporized working medium is directed to the first boiler. The working medium evaporates in the first boiler where the big temperature difference between the working medium and the exhaust gases results in a very efficient and easily controlled cooling of the exhaust gases before they enter the exhaust treatment component. In general, this measure makes it possible to cool the exhaust gases and the exhaust treatment component to a temperature within said optimal temperature range. The second valve device may comprise a three way valve. Alternatively, the second valve device may comprise a two-way valve arranged in the second conduit and another two way valve arranged in the second bypass conduit.

According to an embodiment of the invention, the arrangement comprises a first exhaust line of the exhaust system directing exhaust gases to the first boiler, a first exhaust bypass line directing exhaust gases past the first boiler, and a first exhaust valve device configured to regulate the exhaust flow through said first exhaust line and the first exhaust bypass line. The heat transfer in the first boiler depends on the temperature and the flow rate of the working medium and the temperature and the flow rate of the exhaust gases. In this case, it is possible to control the proportion of the exhaust gases to be directed to the first boiler and thus the temperature of the exhaust gases entering the exhaust treatment component. The first exhaust valve device may comprise a first butterfly valve arranged in the first exhaust line and a second butterfly valve arranged in the first exhaust bypass line. Alternatively, the first exhaust valve device may comprise only one butterfly valve arranged in the first exhaust bypass line.

According to an embodiment of the invention, the arrangement comprises a second exhaust line of the exhaust system directing exhaust gases to the second boiler, a second exhaust bypass line directing exhaust gases past the first boiler, and a second exhaust valve device configured to regulate the exhaust flow through said second exhaust line and the second exhaust bypass line. In this case, it is possible to adjust the proportion of the exhaust gases to be directed to the second boiler and the heating of the working medium in the second boiler. The second exhaust valve device may comprise one or several butterfly valves.

According to an embodiment of the invention, the arrangement comprises a control unit configured to receive information about at least one operating parameter and to control the first valve device by means of said parameter. Such a control unit may be a computer unit provided with a suitable software. The control unit may also control one or several of the second valve device, the first exhaust valve device and the second exhaust valve device.

According to an embodiment of the invention, said control unit is configured to receive information about a parameter related to the temperature of the exhaust treatment component and to control the first valve device by means of said parameter. In this case, the arrangement may comprise a temperature sensor sensing the temperature of the exhaust treatment component. Alternatively, a temperature sensor may be arranged in the exhaust system in a position immediately downstream of the exhaust treatment component. The exhaust gases leaving the exhaust treatment component have a temperature related to the temperature of the exhaust treatment component.

According to an embodiment of the invention, said control unit may be configured to receive information about the temperature of the exhaust gases in a position upstream of the exhaust treatment component and to control the first valve device by means of said information. In this case, the arrangement may comprise a temperature sensor sensing the temperature of the exhaust gases in a position upstream of the first boiler or downstream of the first boiler. The control unit may regulate the first valve device such that the exhaust gases receive a cooling in the first boiler to a temperature within said optimal temperature range in which the exhaust treatment component has an optimal efficiency.

According to an embodiment of the invention, said control unit may be configured to receive information about the exhaust flow rate in the exhaust system and to control the first valve device by means of said information. The control unit may, for example, receive information from an engine control unit about the exhaust gas flow in the exhaust system. A high exhaust flow in the exhaust system results in a higher heat transfer rate in the first boiler and the second boiler than a low exhaust flow.

According to an embodiment of the invention, said control unit may be configured to receive information about an operating parameter of the WHR system and to control the first valve device by means of said information. The control unit may for example receive information about the evaporation temperature of working medium, the superheating of the working medium, the condensation temperature of working medium and the supercooling of the working medium.

According to an embodiment of the invention, the exhaust treatment component is a SCR catalyst. The ability of a SCR catalyst to reduce nitrogen oxides is optimal within a temperature range which may be about 300-450° C. At lower and higher exhaust gas temperatures the capacity of the SCR catalyst to reduce nitrogen oxides is reduced. The exhaust gases are used to vaporize a urea solution before they enter the SCR catalyst. As a consequence, the temperature of the exhaust gases in a position downstream of the SCR catalyst can be considerably lower the temperature of the exhaust gases in a position upstream of the SCR catalyst. In this case, it is preferable to use the first boiler which is located upstream of the SCR catalyst in an optimal manner. Alternatively or in combination, the exhaust treatment component may include an oxidation catalytic converter DOC, a particulate filter DPF, or an ammonia slip catalytic converter ASC.

### BRIEF DESCRIPTION OF THE DRAWING

In the following a preferred embodiment of the invention is described, as an example, with reference to the attached drawing, in which:

FIG. 1 shows an arrangement for an exhaust system of a combustion engine.

### DETAILED DESCRIPTION OF A PREFERRED EMBODIMENT OF THE INVENTION

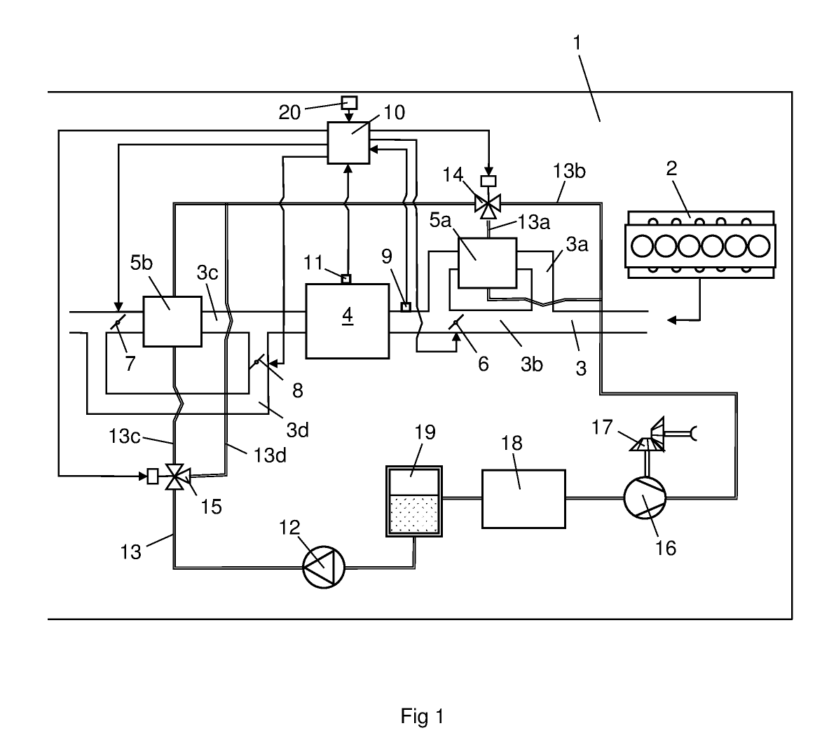

FIG. 1 shows a schematically disclosed vehicle 1 powered by a supercharged combustion engine 2. The combustion engine 2 may be a diesel engine. The vehicle 1 may be a heavy vehicle. The vehicle 1 comprises an exhaust system 3 receiving exhaust gases from the combustion engine 2. A schematically disclosed exhaust treatment component 4 is arranged in the exhaust system 3. The exhaust treatment component 4 may, for example, be one or more of the following exhaust treatment components namely an oxidation catalytic converter DOC, a particulate filter DPF, a SCR catalytic converter and an ammonia slip catalytic converter ASC. The efficiency of the exhaust treatment component 4 depends on its temperature. The ability of, for example, a SCR catalyst to reduce nitrogen oxides may be optimal within the temperature range 300-450° C. At higher and lower temperatures the capacity of the SCR catalyst to reduce nitrogen oxides is reduced.

The exhaust system 3 comprises a first exhaust line 3a and a first bypass line 3b arranged in parallel. The first exhaust line 3a and the first bypass line 3b are arranged in a position upstream of the exhaust treatment components 4. The first exhaust line 3a is provided with a first boiler 5a of a WHR system. A first exhaust valve 6 regulates the exhaust flow through the first exhaust line 3a and the first bypass line 3b. The exhaust system 3 comprises a second exhaust line 3c and a second bypass line 3d arranged in parallel. The second exhaust line 3c and the second bypass line 3d are arranged in a position downstream of the exhaust treatment component 4. The second exhaust line 3c is provided with a second boiler 5b of the WHR system. A second exhaust valve 7 regulates the exhaust flow through the second exhaust line 3c and a third exhaust valve 8 regulates the exhaust flow through the second bypass line 3d. A temperature sensor 9 senses the temperature of the exhaust gases in exhaust system 3 in a position downstream of the first exhaust line 3a and the first bypass line 3b and upstream of the exhaust treatment component 4. Thus, the temperature sensor 9 senses the temperature of the exhaust gases entering the exhaust treatment component 4. A temperature sensor 11 senses the temperature of at least one of the exhaust treatment components 4. A control unit 10 receives information from the temperature sensors 9, 11 and controls the first exhaust valve 6, the second exhaust valve 7 and the third exhaust valve 8 by means of these information. The exhaust valves 6, 7, 8 may be butterfly valves.

The vehicle is provided with a WHR-system (Waste Heat Recovery system). The WHR system comprises a pump 12 which pressurizes and circulates a working medium in a working medium circuit 13. The working medium may be ethanol, R245fa or other kind of working medium. The working medium circuit 13 comprises a first conduit 13a directing the working medium to the first boiler 5a and a first bypass conduit 13b directing the working medium past the first boiler 5a. A valve device in the form of a first three way valve 14 regulates the working medium flow through the first conduit 13a and the first bypass conduit 13b. The working medium circuit 13 comprises a second conduit 13c directing the working medium to the second boiler 5b and a second bypass conduit 13d directing the working medium past the second boiler 5b. A valve device in the form of a second three way valve 15 regulates the working medium flow through the second conduit 13c and the second bypass conduit 13d.

The pump 12 pressurizes and circulates the working medium to the second three way valve 15. The second three way valve 15 regulates the working medium flow through the second conduit 13c and the second bypass conduit 13d. The working medium may be heated in a first step by exhaust gases in the second boiler 5b. The second conduit 13c and the second bypass conduit 13d end in a common line of the working medium circuit 13 directing the working medium to the first three way valve 14. The first three way valve 14 regulates the working medium flow through the first conduit 13a and the first bypass conduit 13b. The working medium may be heated in a second step by exhaust gases in the first boiler 5a. In case the working medium is heated in two steps, it can be evaporated in the second boiler 5b and superheated in the in the first boiler 5a. The first conduit line 13a and the first bypass conduit 13b end in a common line of the working medium circuit 13 directing the working medium to an expander 16.

The working medium expands in the expander 16. The expander 16 generates a rotary motion which may be transmitted, via a mechanical transmission 17, to a shaft of a drive train of the vehicle 1. Alternatively, the expander 16 may be connected to a generator transforming mechanical energy into electrical energy. The electrical energy may be stored in e.g. a battery. After the working medium has passed through the expander 16, it is directed to a condenser 18. The working medium is cooled in the condenser 18 by, for example, coolant circulated in a cooling system in the vehicle. The working medium is directed from the condenser 18 to a receiver 19. Finally, the working medium is directed from the receiver 19 back to the pump 12.

During operation of the combustion engine 2, the control unit 10 receives substantially continuously information from the sensor 11 about the temperature of the exhaust treatment component 4, information from the sensor 9 about the temperature of the exhaust treatment component 4 and information 20 about the exhaust gas flow rate in the exhaust system 3. The control unit 10 may also receive information from operating parameters of the WHR system. The control unit 10 verifies if the temperature of the exhaust treatment component 4 is within a temperature range in which the exhaust treatment component 4 provide an optimal treatment of the exhaust gases.

During operating conditions when the exhaust treatment component 4 has a lower temperature than said optimal temperature range, it is desired to increase the temperature of exhaust treatment component 4 in order to achieve an optimal treatment of the exhaust gases. In this case, the control unit 10 initiates a movement of the first exhaust valve 6 to a fully open position such that substantially the entire the exhaust gas flow rate in the exhaust system 3 will flow through the first bypass line 3b and past the first boiler 5a. Furthermore, the control unit 10 controls the first three way valve 14 such that it directs the working medium in the WHR system to the first bypass conduit 13b and thus past the first boiler 5a. In this case, the exhaust gases will not be cooled at all by the WHR system before they enter the exhaust treatment component 4. In general, the uncooled exhaust gases will increase the temperature of the exhaust treatment component to a temperature within said optimal temperature range relatively quickly.

In order to use the WHR system in an optimal manner during the above mentioned operating conditions, the control unit 10 initiates a movement of the second exhaust valve 7 to a fully open position and a movement of the third exhaust valve 8 to a closed position such that the entire exhaust flow rate will flow through the second boiler 5b. Furthermore, the control unit 10 controls the second three way valve 15 such that it directs the entire working medium flow rate through the first conduit 13a and the second boiler 5b. In this case, the exhaust gases heat the working medium in the second boiler 5b. The working medium leaving the second boiler 5b is evaporated and preferably superheated. In this case, the second boiler 5b is only used.

During operating conditions when the exhaust treatment component 4 has a higher temperature than said optimal temperature range, it is desired to decrease the temperature of the exhaust treatment component 4. In this case, it is suitable to use the first boiler 5a of the WHR system in an optimal manner. Thus, the control unit 10 initiates a movement of the first exhaust valve 6 to a closed position such that the entire exhaust gas flow rate in the exhaust system 3 will flow through the first exhaust line 3a and through the first boiler 5a. Furthermore, the control unit 10 controls the first three way valve 14 such that it regulates the entire working medium flow rate in the WHR system to the first conduit 13a and thus through the first boiler 5a. In this case, the working medium may be evaporated in the second boiler 5b and superheated in the first boiler 5a. The superheating of the working medium in the first boiler reduces the temperature of the exhaust gases entering the exhaust treatment component 4. This measure may reduce the temperature of the exhaust gases and the temperature of the exhaust treatment component 4 to a temperature within said optimal temperature range.

The above mentioned cooling of the exhaust gases in the first boiler 5a is not always sufficient to reduce the temperature of the exhaust gases to an acceptable temperature before they enter the exhaust treatment component 4. In order to further increase the cooling of the exhaust gases in the first boiler 5a, the control unit 10 initiates a movement of the second three way valve 15 to a position in which it directs the working medium, via the second bypass conduit 13d, past the second boiler 5b. In this case, unvaporized working medium is directed to the first boiler 5a. The hot exhaust gases heat the working medium in the first boiler such that it will be evaporated and superheated before it leaves the first boiler 5a. In this case, it is many times possible to decrease the temperature of the exhaust gases and the temperature of the exhaust gases and the temperature of the treatment component 4 relatively rapidly to a temperature within said optimal temperature range.

During operating conditions when the exhaust treatment component 4 already has a temperature within the optimal temperature range, the primary object is to maintain the temperature of the exhaust treatment component 4 within said temperature range. A secondary object is to use the WHR system in an optimal manner. In this case, the control unit 10 may control the second three way valve 15 such that the entire working medium flow is regulated through second conduit 13c and the second boiler 5b. The control unit 10 initiates a movement of the second exhaust valve 7 to a fully open position and a movement of the third exhaust valve 8 to a closed position such that the entire exhaust flow rate will flow through the second boiler 5b. The working medium obtains a heating by the exhaust gases in the second boiler 5b to a temperature at which it evaporates.

Furthermore, the control unit 10 initiate a movement of the first exhaust valve 6 to a more or less open position such that a part of the exhaust gas flow rate will flow through the first exhaust line 3a and the first boiler 5a and a remaining part of the exhaust gas flow rate will flow through the first bypass line 3b. Furthermore, the control unit 10 controls the first three way valve 14 such that it directs a suitable part of the evaporated working medium in the WHR system to the first conduit line 13a and through the first boiler 5a and a remaining part of the evaporated working medium to the bypass conduit 13b. The heat transfer in the first boiler 5a is related to the flow rate and the temperatures of the working medium and the flow rate and the temperature of the exhaust gases. In this case, it is suitable to cool the exhaust gases to a lowest possible temperature in the first boiler 5a at which the temperature of the exhaust treatment component 4 is maintained within the optimal temperature range.

The invention is not restricted to the described embodiment but may be varied freely within the scope of the claims.

1. An arrangement for an exhaust system of a combustion engine, wherein the arrangement comprises:
at least one exhaust treatment component arranged in the exhaust system;
a first boiler of a Waste Heat Recovery System (WHR) system arranged in an upstream position of the exhaust treatment component in the exhaust system;
a second boiler of the WHR system arranged in a downstream position of the exhaust treatment component in the exhaust system;
a working medium circuit circulating a working medium in the WHR system, wherein the working medium circuit comprises a first conduit directing the working medium to the first boiler, a first bypass conduit directing the working medium past the first boiler, and a first valve device configured to regulate the working medium flow through the first conduit and the first bypass conduit; and
a control unit configured to receive information about at least one operating parameter related to a temperature of the exhaust treatment component and to control the first valve device using said parameter, such that the exhaust treatment component receives a temperature within a specific temperature range at which the exhaust treatment component has an optimal efficiency.

2. An arrangement according to claim 1, wherein the working medium circuit comprises:
a second conduit directing the working medium to the second boiler;
a second bypass conduit directing the working medium past the second boiler; and
a second valve device configured to regulate the working medium flow through said second conduit and the second pass conduit.

3. An arrangement according to claim 1, further comprising:
a first exhaust line of the exhaust system directing exhaust gases to the first boiler;
a first exhaust bypass line directing exhaust gases past the first boiler; and
a first exhaust valve device configured to regulate the exhaust flow through said first exhaust line and the first exhaust bypass line.

4. An arrangement according to claim 1, further comprising:
a second exhaust line of the exhaust system directing exhaust gases to the second boiler;
a second exhaust bypass line directing exhaust gases past the first boiler; and
a second exhaust valve device configured to regulate the exhaust flow through said second exhaust line and the second exhaust bypass line.

5. An arrangement according to claim 1, wherein said control unit is configured to receive information about an exhaust flow rate in the exhaust system and to control the first valve device by means of said received information.

6. An arrangement according to claim 1, wherein said control unit is configured to receive information about a temperature of the exhaust treatment component and to control the first valve device by means of said received information.

7. An arrangement according to claim 1, wherein said control unit is configured to receive information about a the temperature of exhaust gases in a position upstream of the exhaust treatment component and to control the first valve device by means of said received information.

8. An arrangement according to claim 1, wherein said control unit is configured to receive information about an operating parameter of the WHR system and to control the first valve device by means of said received information.

9. An arrangement according to claim 1, wherein the exhaust treatment component is a Selective Catalytic Reduction (SCR) catalyst.

10. A vehicle comprising an arrangement for an exhaust system of a combustion engine, wherein the arrangement comprises:
at least one exhaust treatment component arranged in the exhaust system;
a first boiler of a Waste Heat Recovery System (WHR) system arranged in an upstream position of the exhaust treatment component in the exhaust system;
a second boiler of the WHR system arranged in a downstream position of the exhaust treatment component in the exhaust system;
a working medium circuit circulating a working medium in the WHR system, wherein the working medium circuit comprises a first conduit directing the working medium to the first boiler, a first bypass conduit directing the working medium past the first boiler, and a first valve device configured to regulate the working medium flow through the first conduit and the first bypass conduit; and
a control unit configured to receive information about at least one operating parameter related to a temperature of the exhaust treatment component and to control the first valve device using said parameter, such that the exhaust treatment component receives a temperature within a specific temperature range at which the exhaust treatment component has an optimal efficiency.

11. A vehicle according to claim 10, wherein the working medium circuit comprises:
a second conduit directing the working medium to the second boiler;
a second bypass conduit directing the working medium past the second boiler; and
a second valve device configured to regulate the working medium flow through said second conduit and the second pass conduit.

12. A vehicle according to claim 10, further comprising:
a first exhaust line of the exhaust system directing exhaust gases to the first boiler;
a first exhaust bypass line directing exhaust gases past the first boiler; and
a first exhaust valve device configured to regulate the exhaust flow through said first exhaust line and the first exhaust bypass line.

13. A vehicle according to claim 10, further comprising:
a second exhaust line of the exhaust system directing exhaust gases to the second boiler;
a second exhaust bypass line directing exhaust gases past the first boiler; and
a second exhaust valve device configured to regulate the exhaust flow through said second exhaust line and the second exhaust bypass line.

14. A vehicle according to claim 10, wherein said control unit is configured to receive information about an exhaust flow rate in the exhaust system and to control the first valve device by means of said received information.

15. A vehicle according to claim 10, wherein said control unit is configured to receive information about a temperature of the exhaust treatment component and to control the first valve device by means of said received information.

16. A vehicle according to claim 10, wherein said control unit is configured to receive information about a the temperature of exhaust gases in a position upstream of the exhaust treatment component and to control the first valve device by means of said received information.

17. A vehicle according to claim 10, wherein said control unit is configured to receive information about an operating parameter of the WHR system and to control the first valve device by means of said received information.

18. A vehicle according to claim 10, wherein the exhaust treatment component is a Selective Catalytic Reduction (SCR) catalyst.
